(19) United States
(12) Patent Application Publication
(10) Pub. No.: US 2005/0141866 A1
(43) Pub. Date: Jun. 30, 2005

(54) Data recording-and-reproducing apparatus, data recording-and-reproducing method, program, and recording medium

(75) Inventors: Takashi Aoki, Saitama (JP); Koji Matsuura, Saitama (JP); Yukio Numakami, Saitama (JP); Kenichiro Tada, Saitama (JP); Motooki Sugihara, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/003,760

(22) Filed: Dec. 6, 2004

(30) Foreign Application Priority Data
Dec. 11, 2003 (JP) P. 2003-413237

(51) Int. Cl. H04N 5/783

(52) U.S. Cl. 386/69; 386/95

(57) ABSTRACT

A data recording-and-reproducing apparatus includes a content recording part to record content data on a recording medium, a typical still image generation part to generate a typical still image on basis of the content data, a typical still image storage part to store the typical still image which has been generated, a generation control part to control interruption and resumption of generation of the typical still image, an interruption position information storage part to store interruption position information showing an interruption position in the content data when the generation of the typical still image is interrupted, and a resumption part to resume the generation of the typical still image on basis of the interruption position information when the generation of the typical still image is resumed.

### BACKGROUND OF THE INVENTION

1. Field of the Invention

The present invention relates to a data recording-and-reproducing apparatus, a data recording-and-reproducing method, a program, and a recording medium.

2. Description of the Related Art

A recording-and-reproducing apparatus, such as a DVD (Digital Versatile Disk) recorder or a hard disk recorder, can record and reproduce a large volume of motion picture data and is widely utilized for recording and reproducing, e.g., a long-hour movie. In the case of the DVD, hard disk drive or the like in which such a large volume of motion picture data is recorded, easy random access to portions of the motion picture data which a user desires to view or listen to is desired. Thereby, the user can sense ease of use of an audio visual (AV) device.

Therefore, the user has hitherto manually, additionally recorded chapters of motion picture data which are being recorded, and the motion picture data can be reproduced on a per-chapter basis while the chapters are taken as guidelines. However, operation for recording the chapters is burdensome to the user. Therefore, there is described an invention for preparing thumbnail images as a typical still image of each chapter from a motion picture image acquired after switching of a video scene in one piece of motion picture data (see, e.g., JP-A-11-284948).

### SUMMARY OF THE INVENTION

However, in order to prepare typical still images from a motion picture in the previously mentioned manner, motion picture data must be retrieved, and still images of respective video scenes must be extracted from the motion picture data. Particularly, operation for retrieving switching between video scenes to prepare a typical still image requires complicated processing. Consequently, a long period of time is consumed before completion of generation of typical still images. Hence, the user is caused to await completion of generation of typical still images and thus feels inconvenience.

Problems to be solved by the present invention include, as examples, solution of a problem of laborious manual chapter recording operation, solution of a problem of a necessity for performing an enormous amount of complicated arithmetic operation to generate a typical still image, and solution of a problem of a delay in a typical still image generation speed due to the enormous amount of arithmetic operation.

According to an aspect of the present invention, a data recording-and-reproducing apparatus includes a content recording part to record content data on a recording medium, a typical still image generation part to generate a typical still image on basis of the content data, a typical still image storage part to store the typical still image which has been generated, a generation control part to control interruption and resumption of generation of the typical still image, an interruption position information storage part to store interruption position information showing an interruption position in the content data when the generation of the typical still image is interrupted, and a resumption part to resume the generation of the typical still image on basis of the interruption position information when the generation of the typical still image is resumed.

According to another aspect of the present invention, a data recording-and-reproducing method includes recording content data on a recording medium, scanning the content data as well as generating typical still images, storing the typical still images which has been generated, controlling interruption and resumption of generation of the typical still images, storing interruption position information showing an interruption position in the content data when the generation of the typical still images is interrupted, and resuming the generation of the typical still images on basis of the interruption position information when the generation of the typical still image is resumed.

According to yet another aspect of the present invention, a data recording-and-reproducing program for realizing a processing to a computer to record and reproduce data, the data recording-and-reproducing method includes recording content data on a recording medium, scanning the content data as well as generating typical still images, storing the typical still images which has been generated, controlling interruption and resumption of the generating the typical still images, storing interruption position information which shows an interruption position in the content data when the generating the typical still images is interrupted, and resuming the generating the typical still images on basis of the interruption position information when the generating the typical still image is resumed.

According to still another aspect of the present invention, a recording medium readable by a computer, the recording medium storing a program of instructions executable by the computer to perform a function for reading and reproducing data, the function includes recording content data on a recording medium, scanning the content data as well as generating typical still images, storing the typical still images which has been generated, controlling interruption and resumption of the generating the typical still images, storing interruption position information which shows an interruption position in the content data when the generating the typical still images is interrupted, and resuming the generating the typical still images on basis of the interruption position information when the generating of the typical still image is resumed.

### BRIEF DESCRIPTIONS OF THE DRAWINGS

FIG. 1 is a block diagram showing a data recording-and-reproducing apparatus according to an embodiment of the present invention;

FIG. 2 is a descriptive view showing an association between respective functional blocks and software for performing respective processing operations of the data recording-and-reproducing apparatus of the embodiment;

FIG. 3 is a flowchart showing procedures of data recording-and-reproducing operation of a data recording-and-reproducing method according to an embodiment of the present invention;

FIG. 4 is a flowchart showing interrupt processing procedures of post processing in the data recording-and-reproducing method according to the embodiment of the present invention; and

FIG. 5 is flowchart showing procedures of resuming post processing after interruption of the post processing in the data recording-and-reproducing method according to the embodiment of the present invention.

### DETAILED DESCRIPTION OF THE INVENTION

An embodiment of the present invention will be described hereinbelow by reference to the drawings.

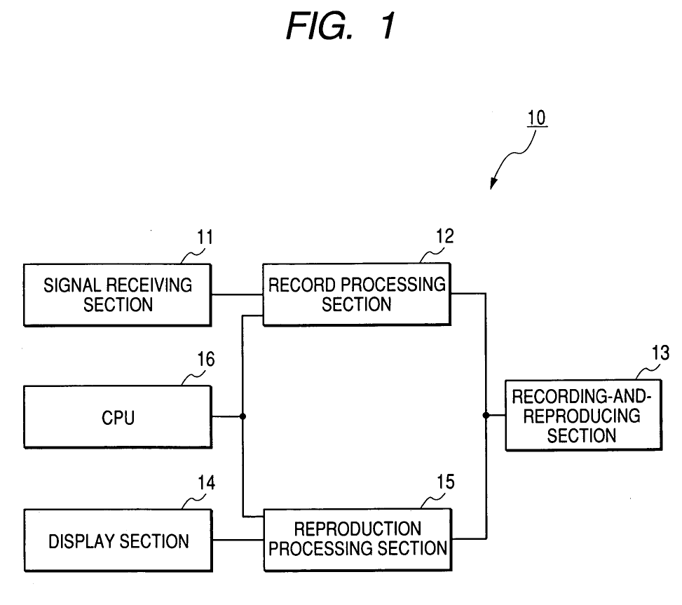

FIG. 1 is a functional block diagram for describing a data recording-and-reproducing apparatus according to an embodiment of the present invention.

As shown in FIG. 1, a data recording-and-reproducing apparatus 10 according to an embodiment of the present invention includes a signal receiving section 11; a record processing section 12; a recording-and-reproducing section 13; a display section 14; and a reproduction processing section 15.

The data recording-and-reproducing apparatus 10 has a typical still image generation part. The typical still image generation part assigns a plurality of chapters which can call a specific video scene from among a plurality of video scenes included in the content data, such as recorded motion pictures. The typical still image generation part generates a plurality of typical still images that represent video scenes of the respective chapters in an abbreviated manner, by extracting a still image (e.g., image of an arbitrary frame) among the video scenes of the content data. The typical still image should be a thumbnail image which is displayed on a small screen by compressing and scaling-down a still image of the video scenes.

The signal receiving section 11 of the data recording-and-reproducing apparatus 10 shown in FIG. 1 is connected to the recording-and-reproducing section 13 by way of the record processing section 12. The display section 14 is connected to the recording-and-reproducing section 13 by way of the reproduction processing section 15. A CPU (Central Processing Unit) 16 is connected to the recording-and-reproducing section 13 by way of the record processing section 12, as well as by way of the reproduction processing section 15.

The signal receiving section 11 receives the content data from outside the data recording-and-reproducing apparatus 10 and outputs the thus-received data to the record processing section 12.

The record processing section 12 processes the thus-input content data so as to make the same suitable for recording, outputs the thus-processed data to the recording-and-reproducing section 13, and records the data on the recording medium.

The reproduction processing section 15 reads the data recorded on the recording medium by the recording-and-reproducing section 13 and processes the thus-read data so as to make the same suitable for reproduction.

The display section 14 displays the image data included in the content data processed by the reproduction processing section 15, texts indicating information unique to the recording medium, or the like, so that the data and texts can be visually ascertained on a screen.

The CPU 16 controls and manages the record processing section 12, the recording-and-reproducing section 13, and the reproduction processing section 15.

A DVD, a hard disk drive, or the like, which enables recording and reproduction of a digital signal, is used as the recording medium.

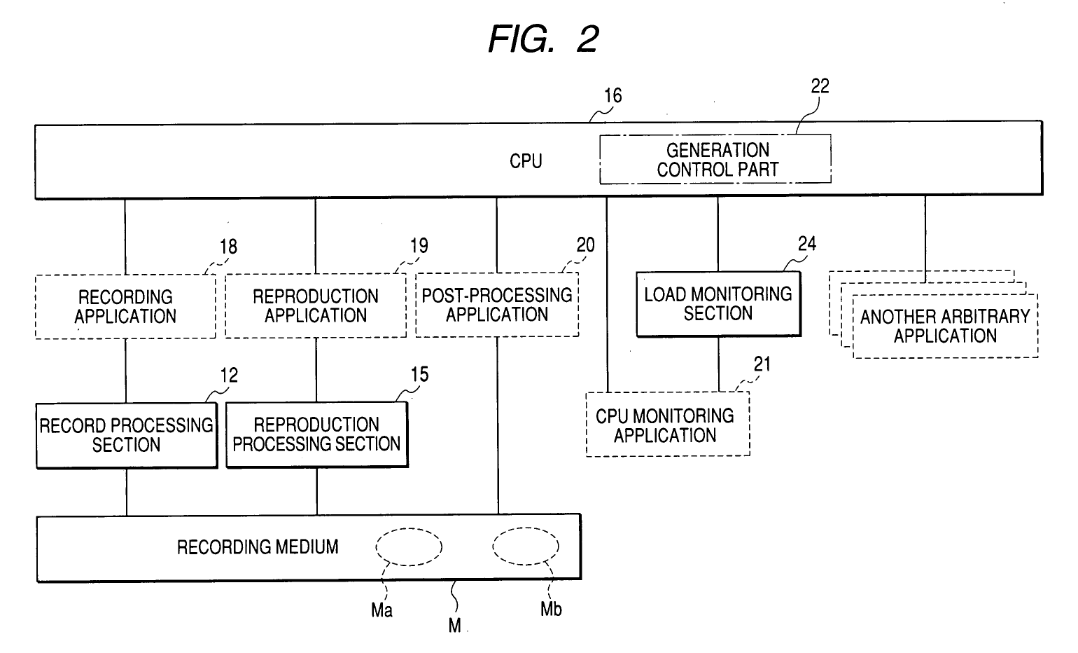

FIG. 2 is a descriptive view showing relationships between respective functional blocks and application software for performing processing operations of the data recording-and-reproducing apparatus 10 shown in FIG. 1.

The CPU 16 controls the record processing section 12 through use of application software 18 (a recording application) for recording purpose, thereby recording the content data on a recording medium M.

The CPU 16 controls the reproduction processing section 15 through use of application software 19 for reproduction purpose (a reproduction application) and reproduces the content data recorded in the recording medium M.

The CPU 16 generates typical still images by detecting a motion picture-which is to be acquired after switching of a video scene and to be taken as a typical still image e.g., by scanning the content data from the head thereof, through use of existing means or the like, by way of post-processing application software (a post-processing application) 20 which is a typical still image generation part. The thus-generated typical still image is recorded in a storage area Ma (a typical still image storage part) in the recording medium M.

The CPU 16 controls the interruption position information storage part, to thus store, in a storage area Mb (an interruption position information storage part) in the recording medium M, interruption position information indicating an interruption position in the content data when generation of the typical still image is interrupted. Here, the interruption position is, e.g., a position where scanning operation is interrupted. An address in the recording medium M is considered, e.g., the interruption position information.

The CPU 16 controls the resumption part, to thus resume generation of the typical still image on the basis of the interruption position information when generation of the typical still image is resumed. Here, resumption means initiation of scanning of an area of, e.g., the content data, other than the areas which have already been scanned; that is, scanning of an area which has not yet been scanned for detecting thumbnail images, from the position where the previous scanning operation has been interrupted; namely, the position of interruption indicated by the interruption position information.

The CPU 16 further examines an idle time of the CPU 16 through use of application software for monitoring a CPU 21 (a CPU monitoring application).

When the load imposed on the CPU 16 has reached a predetermined threshold value or more or when the load has become equal to or less than the predetermined threshold value, a load monitoring section 24 notifies the monitoring application software 21 of this fact. Upon receipt of the notification, the CPU monitoring application software 21 issues an interrupt notification to the CPU 16 acting as a generation control part 22, thereby causing the post-processing application software 20 to stop or resume operation.

For instance, when the CPU 16 is instructed to reproduce or stop content data upon receipt of a signal from an unillustrated input part (e.g., an unillustrated light-receiving section for receiving an optical signal from a remote controller operated by the user), the load imposed on the CPU 16 changes. Consequently, the CPU 16 acts as the generation control part 22 and controls interruption and resumption of generation of the typical still image.

The CPU 16 can also execute other, arbitrary application software.

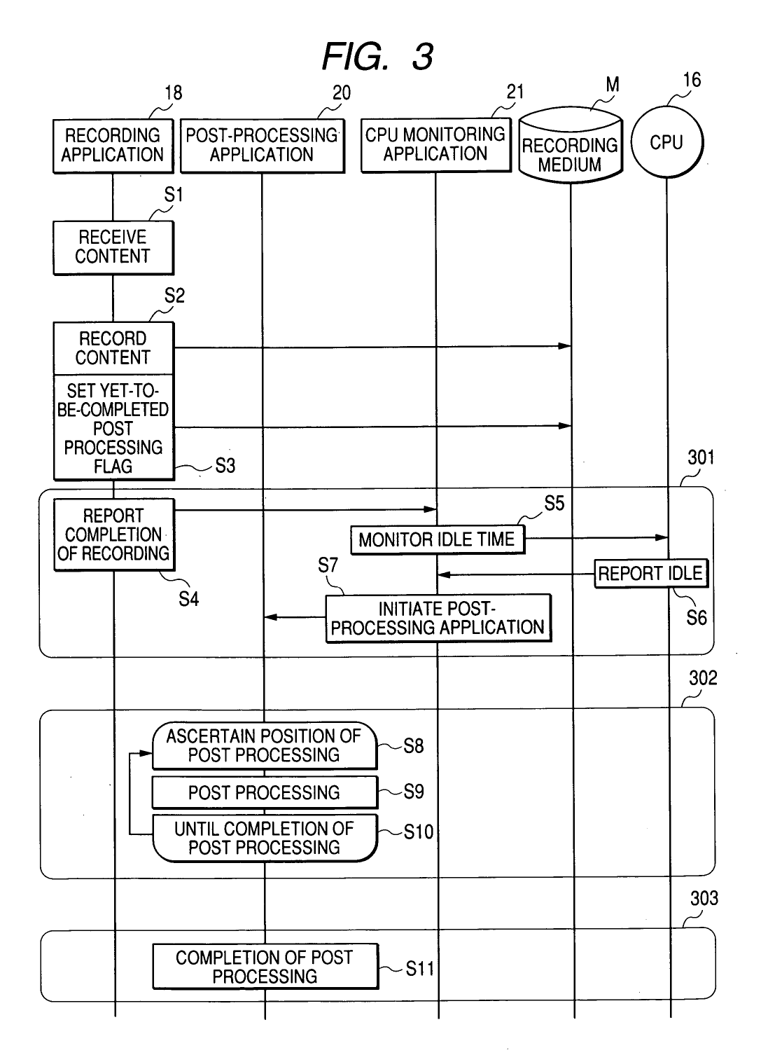

A data recording-and-reproducing method according to the present embodiment will now be described by reference to FIGS. 3 to 5.

Under the data recording-and-reproducing method of the present embodiment, generation of typical still images simply representing details of a video scene is not performed in real time during the course of recording of content data, such as motion pictures, but is carried out separately as post processing after completion of recording of the content data.

FIG. 3 is a flowchart showing procedures of processing steps of the data recording-and-reproducing method using the data recording-and-reproducing apparatus 10 shown in FIG. 1.

In FIG. 3, when the signal receiving section 11 has received the content data (S1), the record processing section 12 records content data in [e.g., MPEG-2TS (a transport stream) data] the recording medium M through use of the application software 18 for recording purpose (S2). Concurrently, a flag of yet-to-be-completed post processing is set (e.g., recording of the MPEG-2TS is initiated, a flag file is prepared at this time, and data of the flag file are taken as “0”) (S3).

In this way, the content data are recorded. When the recording operation has been completed (S4), the application software 21 for monitoring a CPU (hereinafter called the “CPU monitor application software 21”) monitors an idle time of the CPU 16 upon receipt of a completion notification (S5). The CPU 16 reports an idle (a wait for processing) when there is an idle space (S6). Upon receipt of the notification, the CPU monitor application software 21 initiates the application software 20 for post processing purpose (hereinafter called the “post-processing application software 20”) (S7).

When the idle time has passed, the post processing performed by the post-processing application software 20 is interrupted. When the idle time has again become available, the post processing is resumed.

After having ascertained the post processing position at start up (S8), the post-processing application software 20 retrieves the position of the chapter by scanning the content data and initiates post processing, such as generation of a typical still image (S9). Such processing is carried out repeatedly until completion of the post processing (S10). Post processing is completed when all of the content data have been processed (S11), and a completion flag is set. Thus, typical still images are generated through post processing, and the typical still images are stored along with corresponding portions of the content data in the storage area Ma of the recording medium M.

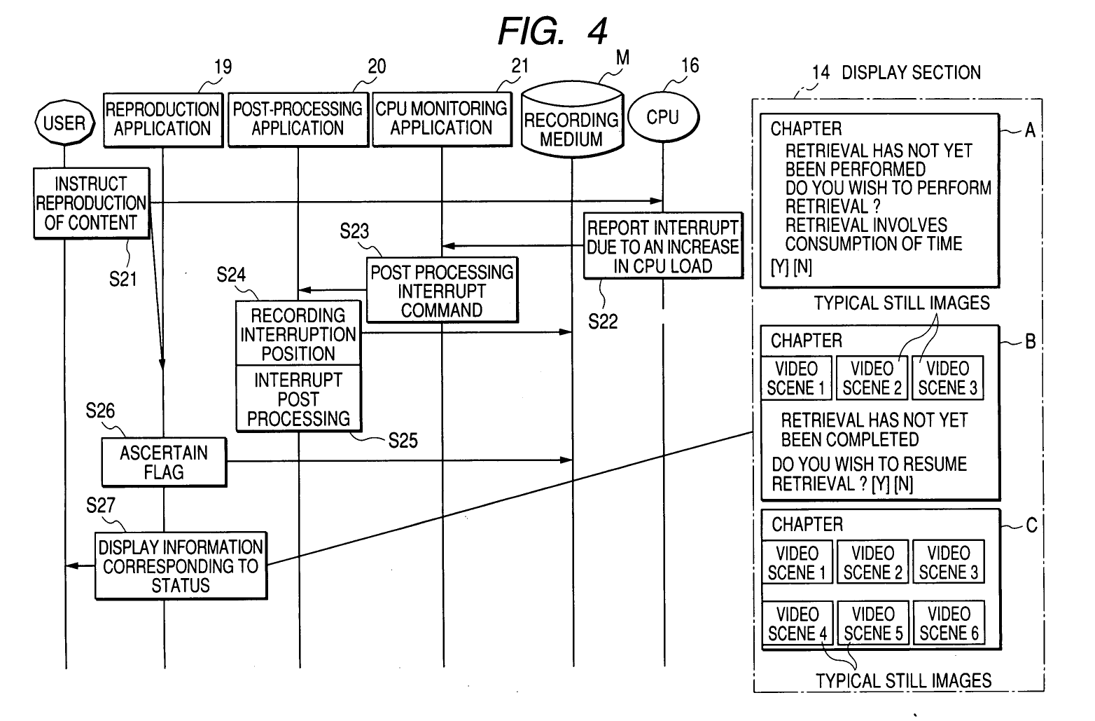

FIG. 4 is a flowchart showing procedures of a step of recording interruption position information showing an interruption position by interrupting the post processing (generation of a typical still image or the like).

When the user instructs reproduction of content data during the course of post processing through use of a remote controller, or the like, which is an unillustrated input part (S21), the content data recorded in the recording medium M are reproduced according to procedures to be described below in detail. Post processing (generation of a typical still image or the like) is interrupted, and interruption position information is recorded.

Specifically, when interruption is generated as a result of the user having issued an instruction for reproducing content data (S21), the reproduction application software is initiated. The CPU monitor application software 21 detects a rise in the load exerted on the CPU 16 (S22). An interrupt notification is sent to the CPU monitor application software 21, whereby a post processing interrupt command is delivered to the post-processing application software 20 (S23).

The post-processing application software 20 records the interruption position information for post processing in a storage area Mb (an interruption position information storage part) in the recording medium M (S24) and interrupts post processing until an instruction for resumption is issued by the CPU monitor application software 21 (S25).

By interruption of the post processing, the reproduction processing section 15 ascertains the post-processing interrupt flag, by executing the reproduction application software 19 (S26), thereby reproducing the content data.

The post-processing interrupt flag is also used for ascertaining a status when information corresponding to a processing status to be displayed on a display section is displayed.

The reproduction processing section 15 displays on the display section 14 information corresponding to a processing status at the time of retrieval of the position of the chapter (S27).

During a processing process 301 pertaining to steps S4 to S7 shown in FIG. 3, a message A, such as that shown in FIG. 4, is displayed as information corresponding to the processing status to be displayed on the display section 14. During a processing process 302 pertaining to steps S8 to S10 shown in FIG. 3, a message B, such as that shown in FIG. 4, is displayed as information corresponding to the processing status to be displayed on the display section 14. During a processing process 303 pertaining to step S11 shown in FIG. 3, a message C, such as that shown in FIG. 4, is displayed as information corresponding to the processing status to be displayed on the display section 14.

As mentioned above, when an interrupt due to reproduction of content data is made during a post processing operation, such as retrieval of the position of a chapter or generation of a typical still image, the post processing is interrupted.

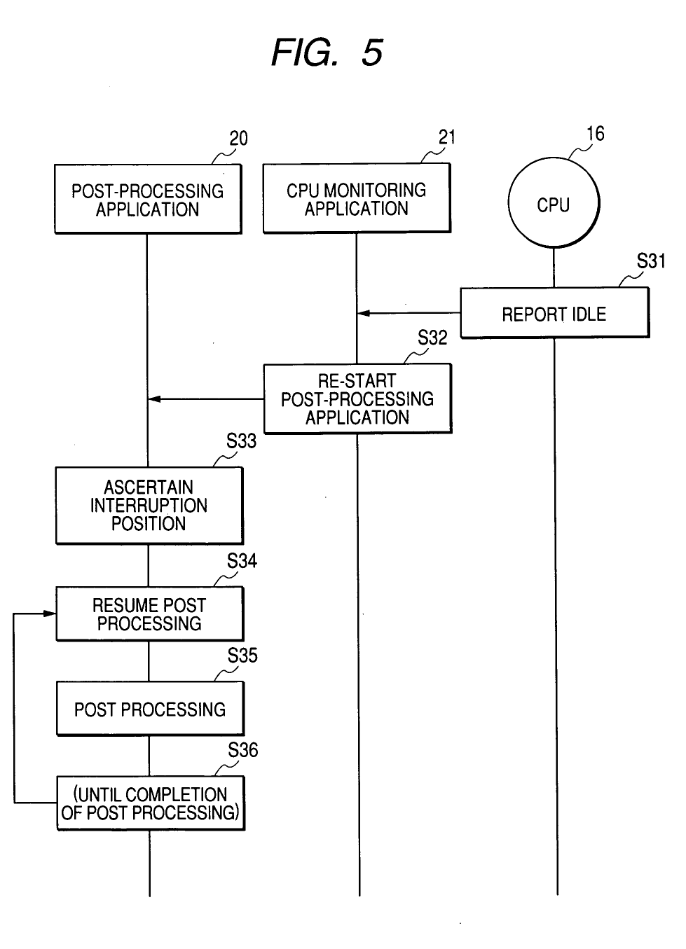

FIG. 5 is a flowchart showing procedures of a process for resuming post processing (generation of a typical still image or the like) on the basis of the interruption position information after interruption of the post processing.

Resumption of the post processing is determined on the basis of whether or not the CPU 16 is idle. When recording of content data or the like is not performed currently and when the CPU 16 is idle, the idle information is delivered to the CPU monitor application software 21 (S31).

For this reason, the CPU monitor application software 21 again initiates the post-processing application software 20 (S32).

The post-processing application software 20 ascertains the interruption position information about the thus-interrupted post processing by retrieving the interruption position information from the memory area Mb in the recording medium M (S33) and resumes the post processing (generation of a typical still image or the like) (S34).

As mentioned above, the post processing is a gain performed (S35), and this processing is repeatedly performed until completion of the post processing (S36). When all of the content data have been processed, the post processing is completed.

Issuance of the instruction for reproducing content to be performed by the user and reproduction of content can be performed at any time, so long as the record processing section 12 has finished recording the content in the recording medium M. At this time, the reproduction application software 19 reads flag information; displays on the display section 14 a message for reporting progress in post processing such as that represented by A, B, and C shown in FIG. 4; and performs processing, such as submission of typical still images which have been available thus far.

As mentioned above, typical stationary images are generated by background operation after recording of the content data. When processing for generating the typical still images has been interrupted, the interruption position is stored, and generation of the typical still images can be resumed from the interruption position.

When assignment of a chapter mark is automated through processing, such as detection of video scenes, a massive amount of data processing such as detection of scenes must be performed. According to the present embodiment, a lower priority is assigned to such data processing involving consumption of much time, whereby the stress to be imposed on the user can be alleviated. Moreover, the data processing is performed as post processing by utilization of an idle time of the CPU 16, and hence ordinary operation of the user is not impeded.

Upon receipt of the notification indicating that the idle time of the CPU 16 has run out, a flag pertaining to progress to be updated is provided. Even when the post processing has not been fully completed, the user can perform the minimum operation. The user can predict an end time by ascertaining progress in operation, thereby enhancing convenience of the user.

Initiation of the post-processing application software 20 is performed by the CPU monitor application software 21 dynamically monitoring an idle time. Post processing can also be performed at regular time intervals during a time period from midnight to early in the morning in which users' operations are considered to be few, a time when a power source of the apparatus is in standby condition, or a time period during which the user is considered to perform few operations, as determined by learning the user's tendency of operation. As a result, when post processing is performed, a constant load required during an idle time of the CPU 16 can be alleviated.

A “post processing completion” flag may be set only after progress in post progress has been fully completed without involvement of a sequential update. In this case, the flag area requires only one bit, and the present method can also be applied to an operation having the property of inhibiting submission of the progress of post processing to the user.

When the post processing is interrupted very near the end of the processing, a message “Processing will finish soon. Don't you want to continue the processing?” can also be displayed by comparing the total size of a file with the position of a pointer in the file acquired when processing is interrupted.

In addition to a method for scanning motion picture content data from the head thereof, another method for scanning motion picture content data from the end thereof can also be conceived as a method for scanning motion picture content data to be used for generating a typical still image.

In addition to an address in the recording medium M, information about a time elapsed from the head of motion picture content data, information about a relative time elapsed from a point in time when a chapter is started, and count information about the number of still image data sets (e.g., pictures) from the head of the data included in the content, are also conceivable as the interruption position information.

Generation of a typical still image can also be performed even when the user has not performed operation for a given period of time other than when the load is at a predetermined level or less.

As mentioned in detail, the data recording-and-reproducing apparatus 10 of the present invention includes a content recording part (the record processing section 12) to record content data in the recording medium M; a typical still image generation part (the post-processing application software 20) which scans the content data and generates typical still images; a typical still image storage part (the storage area Ma) to store the thus-generated typical still images; a generation control part 22 to control interruption and resumption of generation of a typical still image; an interruption position information storage part (the storage area Mb) to store the interruption position information showing an interruption position in the content data; and a resumption part to resume generation of the typical still image on the basis of the interruption position information when generation of the typical still image is resumed.

As a result, when processing for generating a typical still image or the like involving consumption of time is continuously performed during an idle time of the CPU when the user performs no operation or when the typical still image generation processing can be interrupted by the user, the typical still image generation part can be resumed from the previously-interruption position by storing the interruption position.

Accordingly, the typical still image can be automatically afforded at a timing at which scenes of the motion picture content data on the recording medium are switched, or at every given time interval.

1. A data recording-and-reproducing apparatus comprising:
a content recording part to record content data on a recording medium;
a typical still image generation part to generate a typical still image on basis of the content data;
a typical still image storage part to store the typical still image which has been generated;
a generation control part to control interruption and resumption of generation of the typical still image;
an interruption position information storage part to store interruption position information showing an interruption position in the content data when the generation of the typical still image is interrupted; and
a resumption part to resume the generation of the typical still image on basis of the interruption position information when the generation of the typical still image is resumed.

2. The data recording-and-reproducing apparatus according to claim 1, further comprising:
a central processing unit to control recording and reproducing operations; and
a load monitoring section to monitor a load imposed on the central processing unit, wherein,
when the load is a predetermined level or less, the typical still image is generated.

3. The data recording-and-reproducing apparatus according to claim 1, wherein
the interruption position information are represented by an address of the recording part where the content data are scanned, when generation of the typical still image is interrupted.

4. The data recording-and-reproducing apparatus according to claim 2, wherein
the interruption position information are represented by an address of the recording part where the content data are scanned, when generation of the typical still image is interrupted.

5. A data recording-and-reproducing method comprising:
recording content data on a recording medium;
scanning the content data as well as generating a typical still image;
storing the typical still image which has been generated;
controlling interruption and resumption of generation of the typical still image;
storing interruption position information showing an interruption position in the content data, when the generation of the typical still image is interrupted; and
resuming the generation of the typical still image on basis of the interruption position information when the generation of the typical still image is resumed.

6. The data recording-and-reproducing method according to claim 5, wherein
in the generating the typical still image a load monitoring section is caused to monitor a load imposed on a central processing unit which controls recording and reproduction of content data, and
the typical still image is generated when the load is a predetermined level or less.

7. The data recording-and-reproducing method according to claim 5, wherein
the interruption position information is represented by an address in a file, which records the content data.

8. The data recording-and-reproducing method according to claim 6, wherein
the interruption position information is represented by an address in a file, which records the content data.

9. A data recording-and-reproducing program for realizing a processing to a computer to record and reproduce data, the data recording-and-reproducing method comprising:
recording content data on a recording medium;
scanning the content data as well as generating a typical still image;
storing the typical still image which has been generated;
controlling interruption and resumption of the generating the typical still image;
storing interruption position information which shows an interruption position in the content data, when the generating the typical still image is interrupted; and
resuming the generating the typical still image on basis of the interruption position information when the generating the typical still image is resumed.

10. A recording medium readable by a computer, the recording medium storing a program of instructions executable by the computer to perform a function for reading and reproducing data, the function comprising:
recording content data on a recording medium;
scanning the content data as well as generating a typical still image;
storing the typical still image which has been generated;
controlling interruption and resumption of the generating the typical still image;
storing interruption position information which shows an interruption position in the content data, when the generating the typical still image is interrupted; and
resuming the generating the typical still image on basis of the interruption position information when the generating of the typical still image is resumed.
